(19) United States
(12) Patent Application Publication
(10) Pub. No.: US 2005/0254653 A1
(43) Pub. Date: Nov. 17, 2005

(54) Pre-authentication of mobile clients by sharing a master key among secured authenticators

(75) Inventors: Alexei Potashnik, Santa Clara, CA (US); Gajendra Shukla, Sunnyvale, CA (US); Daniel Y. Wong, San Jose, CA (US); Emek Sadot, Givataiim (IL); Timothy J. Wilson, Rolling Meadows, IL (US)

Correspondence Address: Robert E. Krebs;Thelen Reid & Priest LLP, P.O. Box 640640, San Jose, CA, 95164-0640, US

(73) Assignee: Proxim Corporation

(21) Appl. No.: 10/923,208

(22) Filed: Aug. 20, 2004

Related U.S. Application Data
(60) Provisional application No. 60/571,065, filed on May 14, 2004.

(51) Int. Cl. H04L 9/00

(52) U.S. Cl. 380/270; 713/171

(57) ABSTRACT

Systems and methods for pre-authenticating a mobile client in a wireless network. Authenticators in a secured section of the wireless network share a master key generated during an authentication session between a mobile client and an authentication server. The shared master key is not allowed to reside on any devices located outside the secured section of the network. Accordingly, the likelihood that the master key may be hijacked is essentially eliminated. A first session encryption key is derived from the master key and used by the mobile client and a first access point during a first communications session. When the mobile client roams to a second access point, a fast authentication process is performed. The fast authentication process retrieves the shared master key and generates a second session encryption key. A full authentication process between the authentication server and the mobile client is not required. The second session encryption key is used by the mobile client and a second access point during a second communications session.

### CROSS-REFERENCE TO RELATED APPLICATIONS

This application claims the benefit of U.S. Provisional Application No. 60/571,065, filed on May 14, 2004.

### FIELD OF THE INVENTION

The present invention relates to authentication of mobile clients accessing a wireless network. More particularly, the present invention relates to methods and apparatus for pre-authenticating mobile clients by sharing a master key among secured authenticators in a wireless network.

### BACKGROUND OF THE INVENTION

Wireless networking, for example, wireless local area networking (WLAN) based on the “Wi-Fi” (IEEE 802.11) standard, has brought substantial benefits to consumers in the enterprise, home, and public access markets. The ability to access a network wirelessly, i.e., without the tether associated with wired networking, enhances user mobility and productivity. Whereas wireless networking provides these benefits, it is beset with unique security vulnerabilities not present in conventional wired networking. For example, because a wireless network is typically based on radio frequency (RF) technology, and information transmitted over the wireless network is not constrained by most physical barriers, an unauthorized user in proximity to the wireless network may be able to connect to the network if proper security measures are not in place.

To avoid the vulnerabilities associated with wireless networking, user authentication processes are typically employed to verify the authenticity of (i.e. to “authenticate”) a client prior to granting the client access to the network. For example, the soon to be ratified IEEE 802.11i standard includes security architecture with operational phases for authenticating a mobile client attempting to connect to the wireless network. The authentication process involves the supplicant (i.e. the mobile client attempting to connect to the network), a wireless access point (AP) through which the supplicant is attempting to access the network, and an authentication server. The authentication process is a mutual authentication process whereby the server and the mobile client are mutually authenticated to each other. A master key (MK) between the mobile client and the authentication server is produced, from which a pairwise master key (PMK) is created and bound to the specific supplicant and the specific AP for their use. The authentication server delivers the PMK to the AP over a secure channel. Next the AP and the supplicant negotiate a pairwise transient key (PTK) from the PMK by way of a four-way handshake mechanism. The PTK is used to secure wireless communication between the AP and the supplicant (i.e. STA). The new and unique PTK is negotiated from the current PMK for each association session between the AP and the supplicant. Once the established link ceases (e.g. following termination of the session allocated to the supplicant) the PMK is discarded.

Authentication of mobile clients requires several packets to be exchanged between the supplicant, authenticator, and a server (typically a RADIUS (Remote Authentication Dial-In User Service server)) every time the mobile client connects to a different AP. The time it takes to fully perform this “re-authentication” of the mobile client, including the time necessary to derive new encryption keys for a new session, can lead to interruptions in data flow. In certain applications, for example voice over IP, such interruptions are not tolerable.

To shorten the re-authentication process, an obvious approach would be to reuse a PMK when the mobile client roams from a first AP to a new AP. In other words, the PMK used at a first AP could be simply passed on to the new AP, thereby negating the time necessary to generate a new PMK. Measures to share the same PMK, as shown for example in FIG. 1, could even be initiated prior to the mobile client roaming to the new AP, thereby effectively “pre-authenticating” the mobile client. Unfortunately, employing such a solution would have the serious security deficiency that if one AP becomes compromised, thereby ultimately revealing the shared PMK to a hijacker, the entire system becomes compromised. Considering the fact that APs are usually installed in hostile environments that are difficult to control or even monitor from a physical security standpoint, this solution is not an acceptable one.

For Wi-Fi WLANs the forthcoming 802.11i standard proposes a pre-authentication process, which may be initiated while a mobile client is still associated to the current AP and before re-associating to a new, or second, AP. Pre-authentication to the new AP creates a new PMK, which allows a mobile client to immediately skip to a four-way handshake after associating with the new AP without having to go through a full re-authentication with the authentication server. Accordingly, the pre-authentication process can be used to shorten the time required to re-authenticate to a new AP, thereby avoiding excessive interruptions in data flow. Whereas the 802.11i pre-authentication process may be employed to accelerate re-authentication and to avoid excessive data flow interruptions, it does not specify or address the architecture needed or required to select the “most likely to roam to” AP, i.e., the AP, from among a plurality of APs, to which pre-authentication should be applied. Pre-authenticating multiple APs might overcome this problem; however, it would impose an excessive load on the network and the back-end authentication structure. Additionally, the 802.11i pre-authentication process does not address the “elevator problem”, in which an AP that a mobile client is about to roam to is not observable by the mobile client at its current position and time.

Another proposed solution, which avoids the “most likely to roam to” and “elevator problem” problems of the proposed 802.11i standard, is the so-called “Alternative Pairwise Key Management” approach. The Alternative Pairwise Key Management approach, which is illustrated in FIG. 2, introduces the idea of creating and using a unique PMK for each AP-mobile client session. Each unique PMK results from a one-way derivation of a master key shared between the backend authentication server and the mobile client. Each derived PMK consists of a hash function of the master key and the MAC address of the associated AP. A benefit of the Alternative Pairwise Key Management approach is that a unique PMK is derived and used for each AP. So, for example, if an eavesdropper intercepts (or derives in any other way) the PMK used for a particular AP-mobile client session, only that session, i.e., not the entire system, becomes compromised. A significant drawback of this approach, however, is that the authentication server software must be modified and supplemented so that it is capable of generating and supporting the PMK derivations. Additionally, because of the extra processing required to generate and support derivations of the unique PMKs, this approach places an extra load on the system.

### BRIEF DESCRIPTION OF THE DRAWINGS

FIG. 1 shows a prior art WLAN in which access points (APs) share a single pairwise master key;

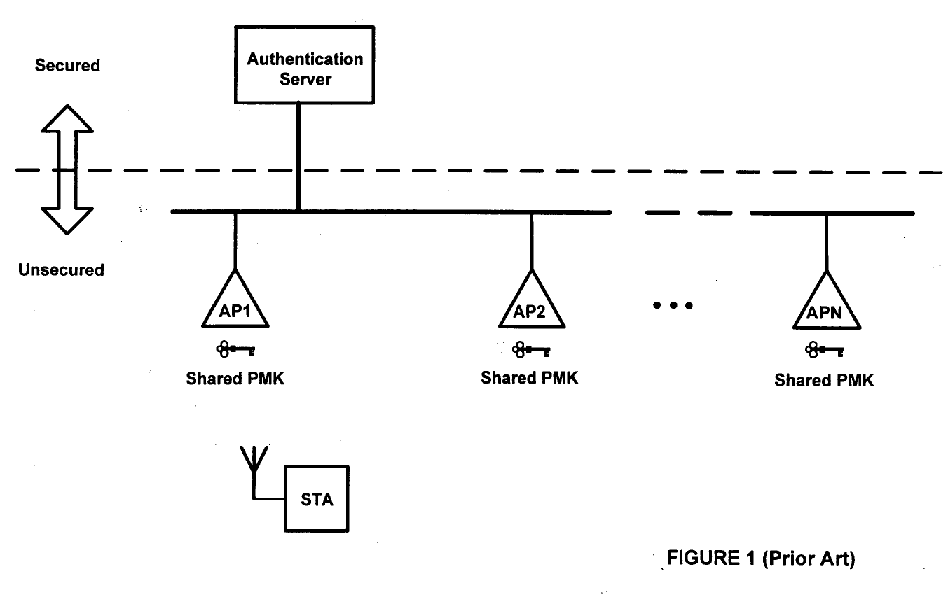

FIG. 2 shows a prior art WLAN utilizing alternative pairwise key management; and

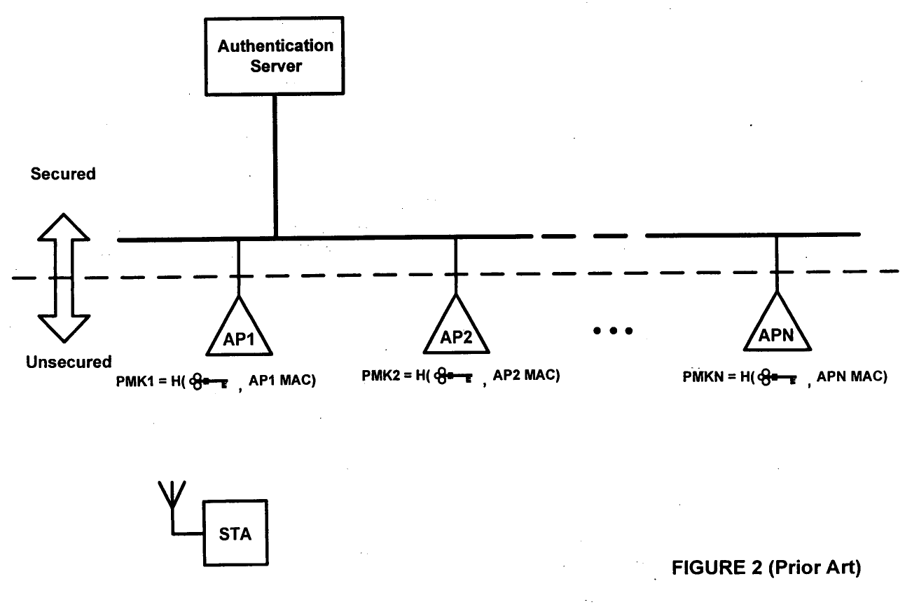

FIG. 3 shows a WLAN system according to an exemplary embodiment of the present invention.

### DESCRIPTION OF THE PREFERRED EMBODIMENTS

Embodiments of the present invention described herein are of apparatus and methods for pre-authenticating mobile clients in a wireless network. Those of ordinary skill in the art will realize that the following detailed description of the preferred embodiments of the invention is illustrative only and is not intended to be in any way limiting. Other embodiments of the invention will readily suggest themselves to such skilled persons having the benefit of this disclosure. Reference will now be made in detail to implementations of the invention as illustrated in the accompanying drawings.

According to an aspect of the invention, a network installation comprises physically secured and unsecured sections. A wiring closet including trusted equipment such as WLAN access controllers and backend servers completely enclosed in it is an example of a secured section. Any kind of wiring or device (such as APs) partially or completely located outside the secured sections of the network is considered unsecured. As discussed in more detail below, because PMKs are prevented from residing on any network components in the unsecured sections of the network, the possibility that the PMKs may become compromised is minimized.

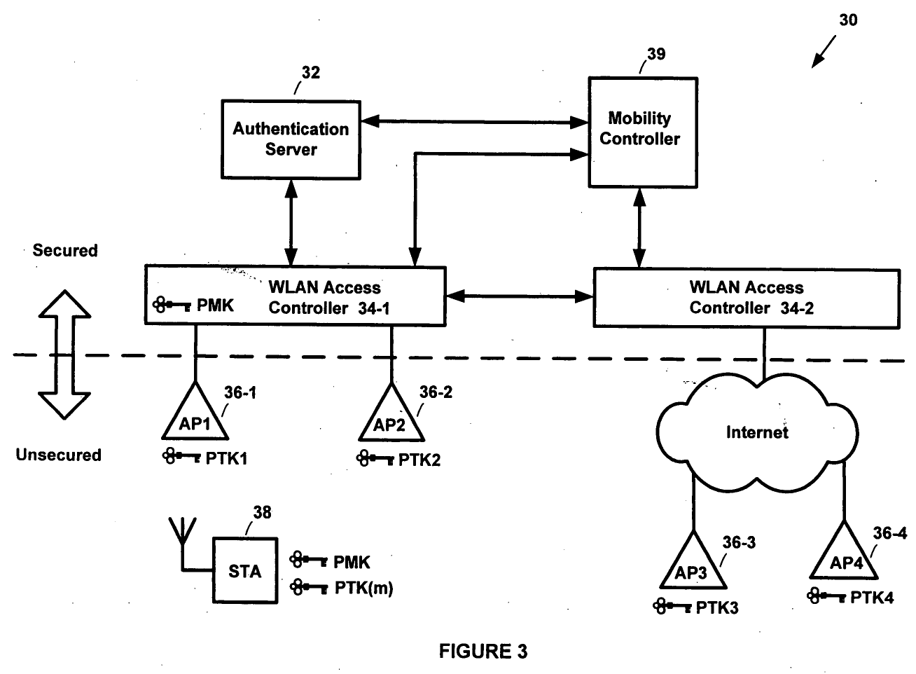

Referring to FIG. 3, there is shown an exemplary diagram of a system 30 implementing various aspects of the present invention. An authentication server 32 and one or more WLAN access controllers 34-1, 34-2, . . . ,34-m are disposed in a secured section of the network, e.g. in a wiring closet. WLAN access controllers 34-1, 34-2, . . . ,34-m may comprise, for example, multi-port switches, single-port appliances, or equivalent devices. For ease of illustration only two WLAN access controllers 34-1 and 34-2 are shown in FIG. 3. Unlike the prior art, the authentication functionality is stored on the WLAN access controllers 34-1, 34-2, . . . ,34-m, and not on the APs 36-1, 36-2, . . . ,36-n, which reside in the unsecured section of the network. Note that depending on system deployment, the APs 36-1, 36-2, . . . ,36-n may be coupled to WLAN access controllers 34-1 and 34-2 directly, as shown by APs 36-1 and 36-2, or indirectly via a network (e.g. the Internet, a WAN, a LAN, etc.), as shown by APs 36-3 and 36-4.

During an initial association with a new AP, say, for example, AP 36-1 (i.e. “AP1”), a mobile client 38 sends one or more packets to AP 36-1 requesting authentication. These one or more request for authentication packets are passed from AP 36-1 to WLAN access controller 34-1. WLAN access controller 34-1 then communicates identifying information of the mobile client 38 to the authentication server 32, which either authorizes the requested connection or sends back a challenge packet to the WLAN access controller 34-1. The WLAN access controller 34-1 will translate and forward the challenge packet to the mobile client 38, via AP 36-1. The mobile client then replies again with its identifying information. These steps are repeated until the authentication server 32 either finally rejects the mobile client 38 or approves of it. If approved, a master key and time parameter characterizing how long authentication of the client will last is sent to and stored on the WLAN access controller 34-1. The mobile client 38 also stores a copy of the master key. AP 36-1 does not store a copy of the master key.

Next, a four-way handshake, similar to that contemplated in the 802.11i standard, is performed. Unlike the 802.11i standard, however, the four-way handshake is performed between the WLAN access controller 34-1 and the mobile client 38, and not between AP 36-1 and the mobile client 38. The four-way handshake verifies that the WLAN access controller 34-1 and the mobile client 38 have the same master key, after which a PTK (pairwise transient key) is generated and stored on the mobile client 38 and the WLAN access controller 34-1. The WLAN access controller 34-1 then sends the PTK to AP 36-1, thereby allowing AP 36-1 to begin communicating traffic (i.e. data packets) to and from the mobile client 38. AP 36-1 uses the PTK to decrypt encrypted data packets received from the mobile client 38 and to encrypt data packets sent to the mobile client 38. The IEEE 802.11i four-way handshake procedure is described in detail in the April 2004 publication of “IEEE Standard for Information technology—Part 11: Wireless Medium Access Control (MAC) and Physical Layer (PHY) specifications: Amendment 6: Medium Access Control (MAC) Security Enhancements”, which is hereby incorporated by reference. Further, those skilled in the art will readily understand that the claims set forth at the end of this disclosure are not limited to systems and methods reliant on the 802.11i standard, and are intended to encompass any WLAN system or method to which pre-authentication may be applicable.

By not allowing PMKs to reside on any devices located outside the secured section of the network, the likelihood that a PMK may be hijacked is essentially eliminated. Further protection against PMK hijacking is provided by only allowing computations associated with the generation and distribution of PMKs to be performed on the WLAN access controllers 34-1, 34-2, . . . , 34-m, on the backend server 32, or on other devices contained completely within the secured section of the network. The only sensitive information delivered from the WLAN access controllers 34-1, 34-2, . . . , 34-m to devices in the unsecured section of the network (for example, the APs 36-1, 36-2, . . . , 36-n) is session specific (e.g. PTK). Therefore, if a PTK is compromised, the compromise will not affect other sessions on other APs.

Once the authentication process described above has been completed, and the PTK is generated and stored on the mobile client 38 and the WLAN access controller 34-1, traffic is allowed to flow between AP 36-1 and the mobile client 38. Subsequently, when the mobile client 38 roams within the range and control of another AP, say, for example, AP 36-2 (i.e. “AP2”), a “fast authentication” process is performed. This fast authentication process includes: (1) retrieval of the mobile client's current PMK and its remaining lifetime; and (2) performing a four-way handshake using the retrieved PMK. According to an aspect of the invention, this fast authentication process need not involve interaction between the authentication server and the mobile client 38. Since the WLAN access controller 34-1 already stores a copy of the PMK, all that needs to be performed to complete an authentication of the mobile client 38 is a four-way handshake between the WLAN access controller 34-1 and mobile client 38. Similar to as described above, this four-way handshake generates a session-specific PTK (i.e. PTK2), which is used only for the session that is ultimately set up for the mobile client 38 and AP 36-2.

As shown in FIG. 3, a mobility controller 39 may also be employed in the exemplary system 30, according to another aspect of the present invention. The mobility controller 39 allows for the use of multiple WLAN access controllers 34-1, 34-2, . . . , 34-m. Because the WLAN access controllers 34-1, 34-2, . . . , 34-m are all situated in a secured part of the network, they can all store the same PMK without the risk of the PMK being hijacked. One function of the mobility controller 39 is to operate as a centralized database storing the identities of all the mobile clients connected to the system and for storing the PMK. After the PMK is generated between the mobile client 38 and the authentication server 32, and the authentication server sends the PMK to the WLAN access controller 34-1, the PMK may also be sent by the WLAN access controller 34-1 to the mobility controller 39. Accordingly, as the mobile client 38 subsequently seeks access to an AP on a different WLAN access controller (for example, WLAN access controller 34-2 in the drawing and AP 36-3), the second WLAN access controller 34-2 contacts the mobility controller 39 to retrieve the PMK. If a PMK is not present, a full authentication process with the authentication server is performed. If the PMK is present, the second WLAN access controller 34-2 stores the PMK, after which the four-way handshake (similar to as described above) is performed.

In addition to avoiding PMK hijacking by preventing PMKs from residing on devices outside the secured section of the network, according to another aspect of the invention PMKs are protected from being hijacked while in transit over unsecured portions of the network. Protection of the PMK while in transit over unsecured parts of the network is achieved by guaranteeing that the PMK always travels over a secure channel with security parameters equal to or stronger than those associated with the PMK itself. For example, a transition of the PMK from one WLAN access controller to another in the network or to and from the system mobility controller 39 may be protected by a TLS tunnel with appropriately chosen authentication, encryption and signing algorithms.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope all such changes and modifications as are within the true spirit and scope of this invention.

1. A wireless network, comprising
an authentication server disposed in a secured environment;
a plurality of authenticators coupled to the authentication server and disposed in the secured environment, at least two of said plurality of authenticators configured to share a master key; and
a plurality of access points coupled to the plurality of authenticators, one or more of the access points configured to store a session specific key.

2. The wireless network according to claim 1 wherein the shared master key comprises a pairwise master key (PMK).

3. The wireless network according to claim 1 wherein the session specific key comprises a pairwise transient key (PTK).

4. The wireless network according to claim 3 wherein a session related access point uses an associated PTK to decrypt data packets received from a mobile client and is used to encrypt data packets sent to the mobile client.

5. The wireless network according to claim 1 wherein the master key shared by said at least two of said plurality of authenticators is used to generate a second session specific key for use in a new session between a mobile client and a second access point.

6. The wireless network according to claim 5 wherein the second session specific key is generated after termination of the original session.

7. The wireless network according to claim 1 wherein one or more of said plurality of authenticators comprises one or more network access controllers.

8. The wireless network according to claim 7 wherein said one or more network access controllers comprises one or more multi-port switches.

9. A method of establishing a communications session in a wireless network, comprising:
performing an authentication session between an authentication server disposed within a secured section of the wireless network and a mobile client located outside the secured section;
storing a master key on an authenticator disposed within the secured section; and
generating a first temporary encryption key for use by the mobile client and a first access point during a first communications session.

10. The method of claim 9, further comprising using said master key to generate a second temporary encryption key for use by the mobile client and a second access point during a second communications session.

11. The method of claim 10 wherein the second temporary encryption key is generated after commencement of the second communications session.

12. The method of claim 9 wherein the authenticator comprises a network access controller.

13. The method of claim 12 wherein said network access controller comprises a multi-port switch.

14. The method of claim 9, further comprising performing a fast authentication process upon the mobile client roaming to a second access point.

15. The method of claim 14 wherein the fast authentication process comprises:
retrieving the master key; and
using the retrieved master key, generating a second temporary encryption key for use by the mobile client and the second access point during a second communications session.

16. A system, comprising:
an authentication server disposed within a secured section of a wireless network;
one or more authenticators within the secured section coupled to the authentication server; and
one or more wireless access points located outside the secured section and coupled to said one or more authenticators,
wherein said one or more authenticators and a properly authenticated mobile client are configured to store a master key, and the mobile client and an access point of the plurality of access points are configured to store a temporary encryption key for use in a current communications session.

17. The system of claim 16 wherein the master key comprises a pairwise master key (PMK).

18. The system of claim 16 wherein the temporary encryption key comprises a pairwise transient key (PTK).

19. The system of claim 16 wherein said one or more authenticators comprises one or more network access controllers.

20. The system of claim 19 wherein said one or more network access controllers comprises one or more multi-port switches.

21. The system of claim 16 wherein the master key is used to generate a second temporary encryption key for use in a second communications session.

22. The system of claim 21 wherein the second communications session occurs following termination of the current communications session.

23. The system of claim 22 wherein the second temporary encryption key is generated after commencement of the second communications session.

24. A system, comprising:
an authentication server disposed in a secured section of a network; and
an authenticator disposed in the secured section of the network, said authenticator configured to store a master key resulting from an authentication process,
wherein said master key is used to generate a first session specific key for use by an authenticated mobile client and an access point coupled to the authenticator during a first communications session.

25. The system of claim 24 wherein the master key is used to generate a second session specific key for use in a new communications session between the mobile client and a second access point.

26. The system of claim 25 wherein the second session specific key is generated after termination of the first communications session.

27. The system of claim 15, further comprising a second authenticator coupled to the first authenticator.

28. The system of claim 27, further comprising a mobility controller coupled to the first and second authenticators.

29. The system of claim 28 wherein said first and second authenticators comprise one or more network access controllers.

30. The system of claim 29 wherein said one or more network access controller comprises one or more multi-port switches.
